(19) United States
(12) Patent Application Publication
(10) Pub. No.: US 2002/0141918 A1
(43) Pub. Date: Oct. 3, 2002

(54) Method and plant for reducing the nitrogen oxides present in the combustion fumes of a gas from a thermolysis process

(76) Inventors: Eric Marty, Lyon (FR); Nicolas Boudet, Lyon (FR); Gerard Henri Martin, Saint Genis Laval (FR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/106,196

(22) Filed: Mar. 27, 2002

(30) Foreign Application Priority Data
Mar. 28, 2001 (FR) 01/04.318

(51) Int. Cl. B01L 7/00

(52) U.S. Cl. 422/198; 422/194; 422/109; 422/110

(57) ABSTRACT

Method allowing to substantially reduce the nitrogen oxides (NOₓ) present in the combustion fumes resulting from thermolysis (or pyrolysis) of a feed comprising an organic matter fraction. The method can be included in a domestic waste treating process.

Plant allowing implementation of said method.

### FIELD OF THE INVENTION

The present invention relates to a method and/or to a plant allowing to substantially reduce the discharge of nitrogen oxides (NOₓ) present in combustion fumes resulting from a thermolysis (or pyrolysis) process. Thermolysis is a process allowing to treat the great majority of waste. More particularly, the invention finds applications in a domestic waste treating process. Without departing from the scope of the invention, it is also possible, according to the invention, to process industrial waste, and more generally any solid feed containing an organic fraction such as, for example, the biomass.

### BACKGROUND OF THE INVENTION

The principle of thermolysis consists in a thermal decomposition of the waste by heating, in the absence of oxygen, in a furnace at the inlet of which said waste is introduced. It is thermally degraded so as to obtain, at the outlet, two reclaimable products: a solid residue rich in carbon-containing substances, that can be used as fuel, and combustible gases having generally a high calorific value (Pci), also referred to as <<thermolysis gases >>. One of the objects of the present invention relates to the reclaiming of these thermolysis gases. Patent FR-2,797,642, mentioned here by way of reference, describes for example a method for implementing a thermolysis process. The most commonly used methods of reclaiming thermolysis gases generally comprise a stage of combustion of said gases in a combustion chamber. The thermal energy of the fumes produced by said combustion is generally recovered by means of a steam or hot water production. Most often, the fumes resulting from the combustion stage thus follow a circuit wherein their thermal energy is recovered in several stages, then they are discharged into the atmosphere.

It is however known that the incineration of waste, domestic waste for example, implies the production of large amounts of nitrogen monoxide NO and nitrogen dioxide NO₂, all of these compounds being referred to by the man skilled in the art as nitrogen oxides or NOₓ. These NOₓ have negative effects on our health and on the natural environment. The use and the development of the domestic waste incineration technique therefore require elimination or at least significant reduction of the amount of nitrogen oxides present in the gaseous combustion effluents. Furthermore, it is essential that the methods and/or devices used are the least costly possible, as regards investment as well as operating costs, and that they are reliable and easy to control and to maintain. Many techniques have been proposed and implemented to reduce the NOₓ discharge level in combustion fumes.

Among these techniques, one of the most efficient ones consists in injecting a reducing compound, generally ammonia or urea, into the chamber itself or more generally in the combustion fumes, allowing chemical reduction of the nitrogen oxides. This reduction can be carried out in the presence of a catalyst. Catalytic reduction however leads to a considerable increase in the cost of the NOₓ reduction process.

According to another technique, it has been proposed to carry out a non catalytic reduction of the NOₓ by a reducing agent comprising an amine function such as ammonia or preferably urea. This technique requires treatment of the thermolysis gas combustion fumes in a temperature range of between about 900° C. and about 1100° C. In fact, the efficiency and the yield of the NOₓ reduction reaction in the absence of a catalyst decrease considerably with temperatures above or below this range. This temperature range depends on the chemical nature of the reducing agent.

Cooling of the combustion fumes in said range can be carried out by injecting air or water into said fumes prior to the treatment. However, the drawback of these solutions is that they cause a high increase in the volume of gas to be treated by said reducing agent. In the case of water injection, corrosion problems may appear, and in the case of air injection, the overall energy efficiency of the plant can be reduced.

According to the present invention, it is possible to keep said temperature range while overcoming the drawbacks linked with the prior solutions such as those described above.

On the other hand, addition of a reducing agent to the combustion fumes can be a potential additional source of final pollution. Thus, when using a compound with at least one amine function or at least one amide function such as urea for example, if said compound is in excess in relation to the nitrogen oxides to be treated or if the treatment is incomplete (for example when the temperature of said fumes is too low), the excess ammonia resulting from the decomposition of said reducing agent will eventually be discharged to the atmosphere. Regulation of the use of such a reducing agent in a non catalytic combustion gas reduction process is another object of the present invention.

Various techniques designed to limit the production of NOₓ and comprising non catalytic reduction of the nitrogen oxides by ammonia or urea in the combustion gases are known from the prior art. For example, European patent application EP-A1-844,014 describes the use of waste-water treatment sludge as the reducing agent. European patent EP-B1-583,771 aims to combine a non catalytic reduction and a catalytic reduction, as well as detection of the proportion of nitrogen oxides and of ammonia in the fumes gases to control the emissions level.

The circuits and methods for treating combustion fumes of gases resulting from the thermolysis of waste are necessarily much more complex to use than those commonly implemented for other energy production plants using commercial fuels such as liquid hydrocarbons (in fuel-oil boilers for example), gaseous hydrocarbons or coal. In fact, the high heterogeneity of the waste treated by thermolysis and its great composition variation with time can lead to high variations in the quality of the thermolysis gases, in terms of composition, calorific value and pollutant content. Great temperature and nitrogen oxides content variations are therefore observed at a given point of the fumes circuit during waste treatment.

### SUMMARY OF THE INVENTION

The object of the present invention thus is a method and a device allowing non catalytic reduction of polluting agents such as nitrogen oxides by means of reducing agents most often comprising at least one amine function. The method is not very costly to implement, in terms of investment as well as operating costs, and it also affords the advantage of being reliable, robust and simple to control and to maintain.

According to the present invention, it is possible to treat waste whose chemical composition varies with time while maintaining in the combustion fumes eventually discharged to the atmosphere low and substantially constant NOₓ and ammonia emission levels.

The present invention relates to a method for treating and reclaiming a feed containing an organic matter fraction, comprising the following stages:

a) thermolysis of said feed substantially in the absence of oxygen,

b) combustion of the gaseous fraction resulting from said thermolysis,

c) cooling of the hot fumes resulting from said combustion so as to bring their temperature into a range favouring non catalytic reduction of the nitrogen oxides present in said fumes by a reducing agent,

d) injection of a solution comprising said reducing agent or a forerunner of said reducing agent into the fumes from stage c),

e) recovery of at least part of the calories of at least part of the fumes from stage d).

According to the invention, cooling of the hot fumes in stage c) is carried out at least partly by recycling at least part of the cold fumes from stage e).

Said feed can comprise for example components rich in organic matter such as, for example, the biomass, industrial waste, domestic waste, sewage treating plant sludge.

Said thermolysis is advantageously carried out in a furnace at least partly heated by at least part of the fumes from stage d).

According to a preferred embodiment, the amount of cold fumes from stage e) recycled to cooling stage c) is varied according to the temperature of the hot fumes from stage b).

The proportion of reducing agent injected in stage d) is generally varied according to the amount of nitrogen oxides contained in the hot fumes from stage b).

Said reducing agent is preferably a nitrogen-containing compound and, more preferably, said nitrogen-containing compound is selected from the group consisting of ammonia, primary amines, secondary amines, amides, urea

The non catalytic reduction of the nitrogen oxides is generally carried out at a temperature ranging between about 900° C. and about 1100° C.

The invention also relates to a plant for treating and reclaiming a feed containing an organic matter fraction, comprising in series:

means intended for thermolysis of said feed,

means intended for combustion of the gaseous fraction resulting from said thermolysis,

means for feeding a solution containing a nitrogen oxides reducing agent into the hot fumes resulting from said combustion,

means intended for recovery of a substantial part of the heat of said hot fumes,

means intended for recycling and mixing a variable part of the cold fumes from the recovery means with the hot fumes from the combustion means.

The thermolysis means is generally a rotary furnace comprising a rotating enclosure into which the feed to be treated is fed, said enclosure being surrounded by a space in which circulates at least part of the hot fumes resulting from said combustion.

The plant also advantageously comprises means for measuring the temperature of the hot fumes present in the vicinity of the zone of delivery of said solution, coupled with means for controlling the flow rate of said recycled cold fumes.

It can also comprise means for measuring the proportion of nitrogen oxides present in the hot fumes from the combustion means, coupled with means for controlling the amount of reducing agent injected through said delivery means.

The method and/or the plant described can be advantageously applied for treating domestic waste, common industrial waste, agricultural waste, sewage treating plant sludge, biomass.

### BRIEF DESCRIPTION OF THE DRAWING

Other features and advantages of the invention will be clear from reading the description hereafter of a non limitative example, illustrated by the accompanying sole figure (FIG. 1).

FIG. 1 is a diagram showing the main elements of a non limitative embodiment of the invention.

### DETAILED DESCRIPTION

The method according to the invention is intended to treat a feed containing an organic matter fraction whose composition is likely to vary considerably with time, such as domestic waste for example. For thermolysis, a rotary furnace 14 is preferably used on account of its capacity to treat feeds of various grain sizes and compositions. The flexibility of this equipment can therefore allow to supply it with a feed containing mixtures of solid compounds that can contain organic matter, such as domestic waste, industrial waste, agricultural waste or sewage treating plant sludge.

Without departing from the scope of the invention, it may be necessary to treat the raw feed prior to thermolysis. This pretreating stage depends on the nature of the feed (composition, grain size, moisture content . . . ) and uses conventional techniques: coarse crushing, drying, etc. The objective of this pretreating stage is to obtain a feed in accordance with the grain size or moisture content specifications for the feed at the inlet of rotary furnace 14.

Rotary furnace 14 used for the thermolysis process comprises a rotating enclosure 25 surrounded by an annular space 13 for heating thereof.

Without departing from the scope of the invention, a thermolysis means such as a moving-hearth or vibrating-table system provided with indirect heating means can be provided.

The feed consisting of waste with, in most cases, heterogeneous compositions is first fed into furnace 14 by a conventional delivery means 1. As it progresses in rotating enclosure 25 and under the action of the heat, the feed is freed of its residual moisture, then it undergoes a thermal degradation in the substantially total absence of air and more particularly of oxygen, i.e. pyrolysis, which leads to the formation of a gas phase (raw gas) and of a carbon-rich solid residue (coke) separated in an element 15, the gas phase being discharged through a line 3 and the carbon-rich solid residue, also called coke, being collected through a line 2. What is meant in the present description by substantially total absence of oxygen is that the volume of oxygen present is less than or equal to 5% and preferably less than or equal to 1% of the total gas volume.

The waste not yet thermolyzed and the gases resulting from the thermal decomposition circulate in a cocurrent flow in pyrolysis furnace 14. This operation is carried out at a temperature ranging between about 300° C. and about 1400° C., preferably between 500° C. and 900° C. and most preferably between 500° C. and 700° C., and at a pressure close to the atmospheric pressure. The residence time of the waste inside the furnace is long enough to allow total degradation of the organic matter contained. It ranges between 30 and 180 minutes, more precisely between 45 and 90 minutes. Under these residence time conditions, and considering the temperature profiles in the rotary furnace, the presence of tars in the gas phase is minimized.

The pyrolysis or thermolysis gases flowing from thermolysis furnace 14 and resulting from the decomposition of the feed are at a temperature ranging between 300° C. and 900° C., preferably between 500° C. and 700° C. These gases include in their composition a mixture of steam resulting from the feed drying operation and from the pyrolysis reactions, of gases not condensable at ambient temperature such as CO, CO₂, H₂, CH₄, C₂Hₓ and C₃H_{y}, NH₃, etc., and vapours of heavier hydrocarbons comprising at least 4 carbon atoms. The gases resulting from the thermolysis process can also contain small amounts of acid gases such as HCl and H₂S, as well as suspended particles.

This gas phase is sent to a reactor or combustion chamber 16 through a connection 3, where combustion of the thermolysis gases is carried out, the oxidizer required for said combustion, most often air, being supplied by a known delivery means 4. During this combustion, the oxidation of the nitrogen-containing compounds contained in the thermolysis gases and/or the oxidation of the molecular nitrogen N₂ contained in the oxidizer are the cause of the formation of NOₓ in the residual fumes of said combustion.

These fumes are discharged through a means 5, and their temperature can range, according to the initial composition of the feed to be treated, between 900° C. and 1600° C., most often between 900° C. and 1200° C.

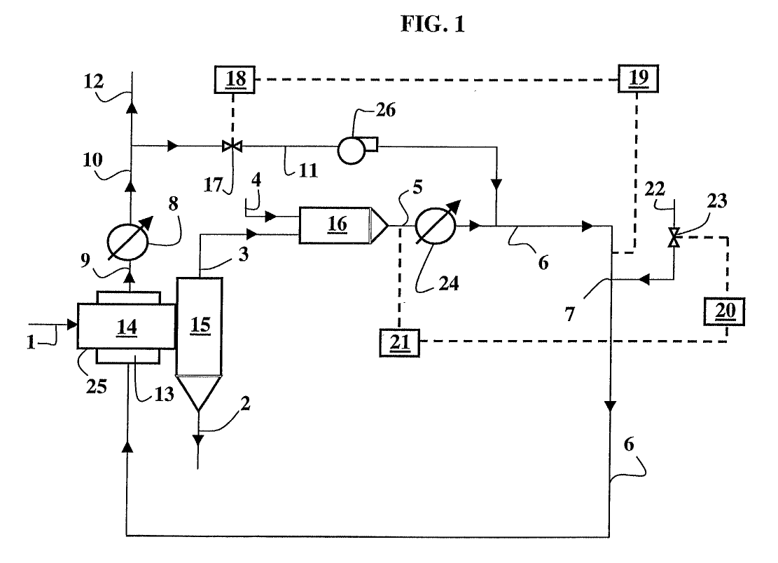

Said combustion is carried out in burners of known technology (not shown in FIG. 1) supplied with a fuel which can comprise at least a fraction of the thermolysis gas. Without departing from the scope of the invention, the burners can also be exclusively supplied with a conventional fuel such as natural gas, liquefied petroleum gas or others.

The thermolysis gas combustion fumes contain a variable pollutant concentration according to the nature of the initial waste. They flow, via a connection 5, through a first energy recovery means or exchanger 24 which can be, for example, a boiler. This equipment according to the invention provides a required and fixed duty cycle, i.e. the amount of heat released by said fumes is not adjustable. In other words, this equipment advantageously allows, which is its sole function, to recover a substantially constant amount of energy but, according to the invention, no temperature regulation is provided for the fumes in order to bring them to a value allowing an effective non catalytic reduction of the nitrogen oxides. Said means 24 is however so dimensioned, according to any technique known to the man skilled in the art, that its outlet temperature is higher than the maximum temperature for which the yield of said reduction is considered to be acceptable by the operator, whatever the temperature of the fumes at the outlet of chamber 16. Although it is advantageous as regards the overall energy recovery, the presence of means 24 is optional within the scope of the present device. It is also possible, without departing from the scope of the invention, to provide a line for bypassing element 24 (not shown), this bypass line being possibly equipped with a valve or an equivalent means allowing to control the flow rate of the fumes.

The hot fumes generated by the combustion of the thermolysis gases are sent through connections 5 and 6 into annular space 13, generally comprising a double wall surrounding rotating enclosure 25, in which they circulate. The circulation of the hot fumes in the double wall can be countercurrent or cocurrent to the solid feed circulating inside furnace 14, according to the desired heating rate and final temperature conditions. The hot fumes circulating in the double wall are at a temperature ranging between 400° C. and 1200° C., preferably between 600° C. and 1000° C. They transfer their energy to the wall of rotating enclosure 25 by radiation and by convection. The fumes then flow, via a line 9, through an element 8 of well-known type allowing to recover at least part, most often a substantial part, of the calories of the combustion fumes. Element 8 can be, according to the invention, any known energy recovery means such as, for example, an exchanger, a steam or hot-water boiler, an economizer, etc. The fumes circulating in line 10 arranged downstream from element 8 are typically cooled to a temperature ranging between about 140° C. and about 250° C. Part of these cold fumes is then discharged through a line 12 to be eventually discharged to the atmosphere, another part is re-injected and mixed, by means of a line 11 and of a fumes circulating means 26, with the hot fumes coming from combustion chamber 16. Said means 16 is generally a fan or a fume extractor of a well-known type. According to the invention, the volume of said injected cold fumes is adjusted so as to cool said hot fumes to a temperature or temperature range for which the yield of the non catalytic nitrogen oxides reduction will be high. This temperature is determined, among other things, according to the reducing agent used in the rest of the circuit and to the proportion of reducing agent supplied. A control valve 17 (or any equivalent means) controlled by a flow control means 18 coupled with a temperature detector 19 thus allows to control and to adjust the proportion or the flow rate of the cold fumes re-introduced through line 11 according to the temperature present in the immediate vicinity of a supply zone 7 for delivering the reducing agent in the combustion fumes circuit. Without departing from the scope of the invention, the use and the regulation of circulating means 26 can be controlled by control means 18, valve 17 being then optional.

The system described above allows, in a very reactive, economical and simple way, to vary the rate of flow of the recycled cold fumes according to the variations of the temperature present at the outlet of combustion chamber 16 and thereafter in zone 7, this temperature being likely to vary considerably and rapidly according to the nature of the initial feed treated.

The solution containing the reducing agent, generally ammonia and preferably urea, is injected into the fumes circuit through a suitable delivery means 22 at the level of zone 7 where the temperature is therefore compatible with a high NOₓ reduction yield, according to the system described above. A control valve 23 (or any equivalent means) controlled by a flow control means 20 coupled with a detector 21 measuring the amount of nitrogen oxides present in the fumes at the outlet of combustion chamber 16 (at the level of connection 5 for example) advantageously allows to control and to adjust in a reactive way the proportion of reducing agent fed into zone 7 according to the chemical composition variations of said fumes.

The present method thus allows, according to the principles and means described above, to effectively reduce the proportion of nitrogen oxides in a fumes stream resulting from the combustion of a thermolysis gas whose temperature is controlled. Said reduction is carried out according to the invention by injection of a suitable amount of reducing agents, adjustable according to the composition variations of said fumes.

1) A method for treating and reclaiming a feed containing an organic matter fraction, including the following stages:
a) thermolysis of said feed substantially in the absence of oxygen,
b) combustion of the gaseous fraction resulting from said thermolysis,
c) cooling of the hot fumes resulting from said combustion so as to bring their temperature into a range favouring non catalytic reduction of the nitrogen oxides present in said fumes by a reducing agent,
d) injection of a solution comprising said reducing agent or a forerunner of said reducing agent into the fumes from stage c),
e) recovery of at least part of the calories of at least part of the fumes from stage d). said method being characterized in that cooling of the hot fumes in stage c) is carried out at least partly by recycling at least part of the cold fumes from stage e).

2) A method as claimed in claim 1, wherein said thermolysis is carried out in a furnace at least partly heated by at least part of the fumes from stage d).

3) A method as claimed in any one of claims 1 or 2, wherein the amount of cold fumes from stage e) recycled to carry out cooling stage c) is varied according to the temperature of the hot fumes from stage b).

4) A method as claimed in any one of the previous claims, wherein the amount of reducing agent injected in stage d) is varied according to the amount of nitrogen oxides contained in the hot fumes from stage b).

5) A method as claimed in any one of the previous claims, wherein said reducing agent is a nitrogen-containing compound.

6) A method as claimed in claim 5, wherein said compound is selected from the group consisting of ammonia, primary amines, secondary amines, amides, urea.

7) A method as claimed in any one of the previous claims, wherein the non catalytic reduction of the nitrogen oxides is carried out at a temperature ranging between about 900° C. and about 1100° C.

8) A plant for treating and reclaiming a feed containing an organic matter fraction, said plant comprising:
means (14) intended for thermolysis of said feed,
means (16) intended for combustion of the gaseous fraction resulting from said thermolysis,
means (22) for feeding a solution containing a nitrogen oxides reducing agent into the hot fumes resulting from said combustion,
means (8) intended for recovery of a substantial part of the heat of said hot fumes, means (11, 26) intended for recycling and mixing part of the cold fumes from said recovery means (8) with the hot fumes from the combustion means.

9) A plant as claimed in claim 8, characterized in that thermolysis means (14) is a rotary furnace comprising a rotating enclosure (25) into which the feed to be treated is fed, said enclosure being surrounded by a space (13) in which at least part of the hot fumes resulting from said combustion circulates.

10) A plant as claimed in claim 8 or 9, characterized in that it also comprises means (19) for measuring the temperature of the hot fumes in the vicinity of a supply zone (7) intended for delivery of said solution, coupled with means (17, 18, 26) for controlling the flow rate of said recycled cold fumes.

11) A plant as claimed in any one of claims 8 to 10, characterized in that it also comprises means (21) for measuring the proportion of nitrogen oxides present in the hot fumes from combustion means (16), coupled with means (20, 23) for controlling the amount of reducing agent injected by said delivery means (22).

12) Application of the method as claimed in any one of claims 1 to 7 and/or of the plant as claimed in any one of claims 8 to 11 to the treatment of domestic waste, common industrial waste, agricultural waste, sewage treating plant sludge, biomass.
